(19) United States
(12) Patent Application Publication
(10) Pub. No.: US 2026/0042371 A1
(43) Pub. Date: Feb. 12, 2026

(54) CHARGING CONTROL DEVICE AND METHOD FOR ELECTRIC VEHICLE

(71) Applicants: Hyundai Motor Company, Seoul (KR); Kia Corporation, Seoul (KR)

(72) Inventors: Tae Wan Kim, Hwaseong (KR); Geun Ok Sin, Hwaseong (KR); Ji Seob So, Hwaseong (KR)

(21) Appl. No.: 19/041,156

(22) Filed: Jan. 30, 2025

(30) Foreign Application Priority Data
Aug. 7, 2024 (KR) 10-2024-0105248

(51) Int. Cl. B60L 53/62; B60L 53/66; B60L 53/68

(52) U.S. Cl. CPC B60L 53/62; B60L 53/66; B60L 53/68

(57) ABSTRACT

A charging control device for an electric vehicle includes a communication unit that receives a first charging voltage and a first charging current of a charger, a sensing unit that measures a second charging voltage of a charging controller for the electric vehicle, which corresponds to the first charging voltage, and a processor that calculates a total resistance of the charging controller and the charger using the first charging voltage, the first charging current, and the second charging voltage, calculates a contact resistance between an inlet of the electric vehicle and the charger by comparing a pre-stored charging controller-side resistance and a pre-stored charger-side resistance with the total resistance, and determines a charging risk degree by comparing the contact resistance with a reference value.

### CROSS-REFERENCE TO RELATED APPLICATION

This application claims under 35 U.S.C. § 119(a) the benefit of Korean Patent Application No. 10-2024-0105248 filed on Aug. 7, 2024, the entire contents of which are incorporated herein by reference.

### BACKGROUND

### 1. Technical Field

The present disclosure relates to a charging control device and method for an electric vehicle.

### 2. Description of the Related Art

When an electric vehicle is charged, the temperatures of a cable (e.g., a high-voltage cable) and a connector (e.g., a high-voltage connector) are increased to heat-resistant temperatures or higher, which can cause a fire. The increase in temperature of the high-voltage connector and the high-voltage cable is caused by the increase in current and resistance according to Joule's law. That is, when an applied current is higher than the allowable currents of the high-voltage connector and the high-voltage cable or a contact resistance increases, the temperatures of the high-voltage connector and the high-voltage cable increase. When electric vehicles are rapidly charged, a considerable high current is applied, and it may be predicted that when a megawatt charging system (MCS) charging method is introduced in the future, very high heat may be generated.

However, a charging current cannot be reduced less than necessary to prevent a fire, and a method of reducing a contact resistance or predicting the occurrence of fire through a contact resistance may be utilized.

Even when vehicles are normally developed and manufactured while taking into account these developments, when the vehicles are charged while an assembly direction of a charging port is misaligned, and when internal foreign substances are introduced during charging, bullet marks or the like caused by arcs that occur during repeated charging are factors that increase a contact resistance of the charging port.

In this situation, when a high current is applied during rapid charging or ultra-high capacity charging, the temperatures of the connector and the cable increase to heat-resistant temperature or higher due to the contact resistance, which may cause a fire.

### SUMMARY

The present disclosure is directed to providing a charging control device and method for an electric vehicle, which are capable of avoiding the possibility of a fire from occurring during charging and determining whether to continuously perform charging.

The present disclosure is also directed to providing a charging control device and method for an electric vehicle, which are capable of avoiding a possibility of a fire from occurring before charging starts and determining whether to start the charging.

According to an embodiment, a charging control device for an electric vehicle includes a communication unit that receives a first charging voltage and a first charging current of a charger, a sensing unit that measures a second charging voltage of a charging controller for the electric vehicle, which corresponds to the first charging voltage, a processor configured to: calculate a total resistance of the charging controller and the charger using the first charging voltage, the first charging current, and the second charging voltage, compare a pre-stored charging controller-side resistance and a pre-stored charger-side resistance with the total resistance and calculate a contact resistance between an inlet of the electric vehicle and the charger, and compare the contact resistance with a reference value and determines a charging risk degree.

For example, the processor may comprise at least first, second, and third processors (or processing units) respectively configured to calculate the total resistance of the charging controller, compare the pre-stored charging controller-side resistance and the pre-stored charger-side resistance with the total resistance, and compare the contact resistance with the reference value.

As a further aspect, a charging control device for an electric vehicle includes a communication unit that receives a first charging voltage and a first charging current of a charger, a sensing unit that measures a second charging voltage of a charging controller for an electric vehicle, which corresponds to the first charging voltage, a first processing unit that calculates a total resistance of the charging controller and the charger using the first charging voltage, the first charging current, and the second charging voltage, a second processing unit that compares a pre-stored charging controller-side resistance and a pre-stored charger-side resistance with the total resistance and calculates a contact resistance between an inlet of the electric vehicle and the charger, and a third processing unit that compares the contact resistance with a reference value and determines a charging risk degree.

The contact resistance may be a variable resistance generated when the inlet is coupled to the charger.

The processor may calculate, as the contact resistance, a resistance value obtained by excluding the charging controller-side resistance and the charger-side resistance from the total resistance.

The charging controller-side resistance may include an inlet resistance of the electric vehicle, a cable resistance, and a connector resistance of the charging controller.

The charging controller side-resistance may be measured using the charging controller and the inlet formed as a closed circuit and stored in a database.

The charger-side resistance may be an internal resistance of the charger.

The processor may output a charging stop signal when the contact resistance is greater than a preset first reference value and output a control command for reducing the first charging current when the contact resistance is greater than a second reference value.

The first reference value may be greater than the second reference value, and the first reference value and the second reference value may be determined based on an initial contact resistance value.

The communication unit may receive charging count information of the electric vehicle, and the processor may calculate an expected contact resistance value using the charging count information and the contact resistance.

The processor may determine whether to perform charging in advance using the expected contact resistance value.

The processor may calculate the expected contact resistance value using an increase in the contact resistance according to the charging count.

The processor may determine that charging is impossible when the expected contact reference value deviates from a preset charging allowable range.

The communication unit may receive temperature information of a charging port, and the processor may determine the charging risk degree using the contact resistance and the temperature information.

An electric vehicle includes the charging control device.

According to an embodiment, a charging control method for an electric vehicle includes receiving, by a communication unit, a first charging voltage and a first charging current of a charger, measuring, by a processor, a second charging voltage of a charging controller for the electric vehicle, which corresponds to the first charging voltage, calculating, by the processor, a total resistance of the charging controller and the charger using the first charging voltage, the first charging current, and the second charging voltage, comparing, by the processor, a pre-stored charging controller-side resistance and a pre-stored charger-side resistance with the total resistance and calculating a contact resistance between an inlet of the electric vehicle and the charger, and comparing, by the processor, the contact resistance with a reference value and determining a charging risk degree.

For example, the processor may comprise at least first, second, and third processors (or processing units) respectively configured to calculate the total resistance of the charging controller, compare the pre-stored charging controller-side resistance and the pre-stored charger-side resistance with the total resistance, and compare the contact resistance with the reference value.

The determining of the charging risk degree may include outputting a charging stop signal when the contact resistance is greater than a preset first reference value and outputting a control command for reducing the first charging current when the contact resistance is greater than a second reference value.

The charging control method may further include, before the determining of the charging risk degree, receiving, by the communication unit, charging count information of the electric vehicle, and calculating an expected contact resistance value using the charging count information and the charging controller-side resistance.

The charging control method may further include determining whether to perform charging in advance using the expected contact resistance value.

The calculating of the expected contact resistance value may include calculating the expected contact resistance value using an increase in the contact resistance according to the charging count.

The determining of whether to perform the charging in advance may determine that charging is impossible when the expected contact resistance value deviates from a preset charging allowable range.

The determining of the charging risk degree may include receiving, by the communication unit, temperature information of a charging port and determining the charging risk degree using the contact resistance and the temperature information.

As provided herein, a processor may comprise one or more processors (or processing units) configured to perform different functions. For example, first, second, and third processors respectively may be configured to calculate total resistance of a charging controller, compare a pre-stored charging controller-side resistance and a pre-stored charger-side resistance with the total resistance, and compare a contact resistance with a reference value.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of an electric vehicle charging system according to an embodiment of the present disclosure;

FIG. 2 is a block diagram of a vehicle;

FIG. 3 is a conceptual view of the electric vehicle charging system according to the embodiment;

FIG. 4 is a block diagram of a charging control device for an electric vehicle according to the embodiment;

FIGS. 5 and 6 are views for describing an operation of a second processing unit according to the embodiment;

FIGS. 7 and 8 are views for describing an operation of a third processing unit according to the embodiment;

FIG. 9 is a view for describing an entire operation process of a device according to the embodiment; and

FIGS. 10 and 11A-11B are flowcharts of a charging control method for the electric vehicle according to the embodiment.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

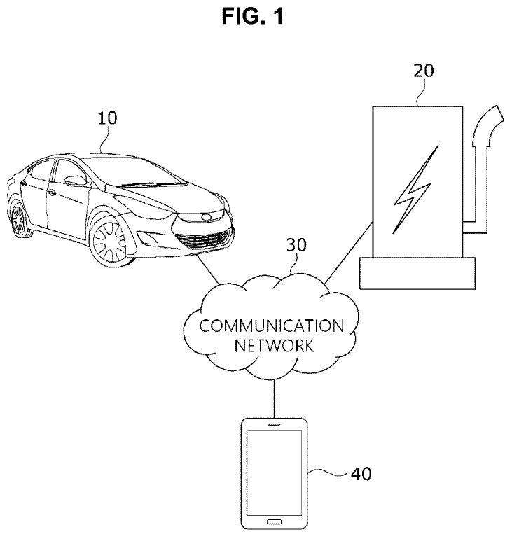

FIG. 1 is a block diagram of an electric vehicle charging system according to an embodiment of the present disclosure. Referring to FIG. 1, an electric vehicle charging system 1 may include a vehicle 10 and a charger 20.

The vehicle 10 is a rechargeable vehicle, which is mainly an electric vehicle, but the present disclosure is not limited thereto, and the vehicle 10 may be a vehicle or the like in which a rechargeable battery is installed. Examples of the electric vehicle may include a hybrid electric vehicle (HEV), a plug-in hybrid electric vehicle (PHEV), an electric vehicle (EV), a neighborhood electric vehicle (NEV), a fuel-cell vehicle (FCV), and the like.

The charger 20 may receive power from a power system and provide power for charging the vehicle 10. The charger 20 may be classified into a slow charger, a rapid charger, an ultra-rapid charger, an ultra-high capacity charger, and the like depending on a charging speed.

The charger 20 may include a communication circuit for connection to a communication network, a microprocessor, a memory for storing charger identification information, and the like. The communication circuit performs wired communication and/or wireless communication. The charger identification information may include location information, identification information, a type of an available charging service, a waiting time, and the like as well as information on the charger.

A communication network 30 may mean a connection structure in which information may be exchanged between nodes such as a plurality of terminals and a plurality of servers and may be a public switched telephone network (PSTN), a public switched data network (PSDN), an integrated services digital network (ISDN), a broadband ISDN (BISDN), a local area network (LAN), a metropolitan area network (MAN), a wide LAN (WLAN), or the like.

However, the present disclosure is not limited thereto, and the communication network 30 may be a code division multiple access (CDMA), a wideband code division multiple access (WCDMA), a wireless broadband (WiBro), a wireless fidelity (WiFi), a digital living network alliance (DLNA), a ZigBee, a Z-wave, a high speed downlink packet access (HSDPA) network, a Bluetooth, a radio frequency identification (RFID), an infrared data association (IrDA), a ultra-wide band, a wireless universal serial bus (wireless USB), a near field communication (NFC) network, a satellite broadcasting network, an analog broadcasting network, a digital multimedia broadcasting (DMB) network, etc., which are wireless communication networks. Alternatively, the communication network 30 may be a combination of these wired communication networks and wireless communication networks.

A terminal 40 is connected to the vehicle and/or the communication network to function to provide information. The terminal 40 may be a smart phone, a laptop computer, a note pad, or the like.

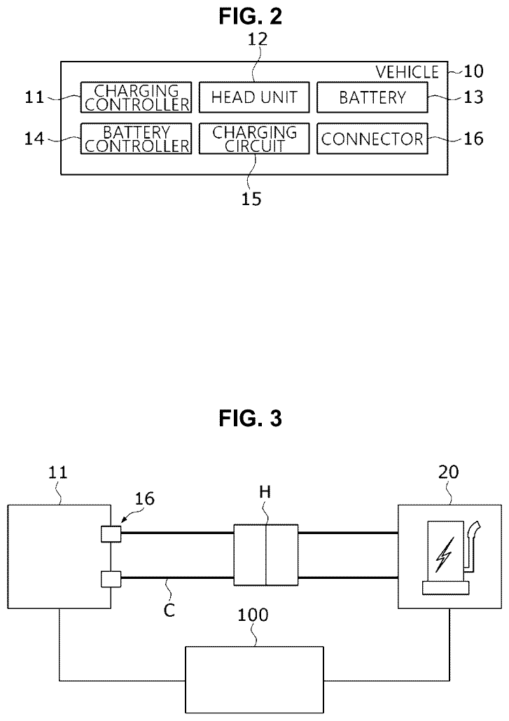

FIG. 2 is a block diagram of a vehicle, and FIG. 3 is a conceptual view of the electric vehicle charging system according to the embodiment. Referring to FIGS. 2 and 3, the vehicle 10 may include a charging controller 11 that controls the entire vehicle, a head unit 12 that outputs information, a battery controller 14 that controls a battery 13, a charging circuit 15 that charges the battery 13, a connector 16, and the like.

In the embodiment, the charging controller 11 may mean a device that is connected to a charger inlet cable and performs a charging control function, a converter function, and a power distribution box function. The charging controller 11 may perform a controlling function while receiving or transmitting signals from or to components constituting the vehicle 10. To this end, the charging controller 11 may include a microprocessor, a microcomputer, a communication circuit, a memory, and the like. Further, the charging controller may be connected to the terminal by wire or wirelessly.

The head unit 12 provides vehicle information, an entertainment interface, and the like. The head unit 12 includes a radio, a digital versatile disc/compact disc (DVD/CD), a USB MP3, a dashcam, a navigation system, Bluetooth, Wi-Fi, a display, and the like. The navigation system may be an audio-video-navigation (AVN) system. Further, functions such as voice control and motion recognition are integrated. To this end, the microprocessor, the microcomputer, the communication circuit, the memory, and the like may be configured.

The display may be a liquid crystal display (LCD), a light emitting diode (LED) display, an organic LED (OLED) display, a touch screen, a flexible display, a head up display (HUD), a micro LED, a mini LED, or the like. The touch screen may be used as an input device.

The battery controller 14 may function to control the battery 13. The battery controller 14 may include a battery management system (BMS). The BMS may optimize management of batteries for eco-friendly vehicles and thus serve to improve energy efficiency and increase a lifetime.

The battery controller 14 monitors a voltage, a current, and a temperature of the battery in real time, calculates battery state information based thereon, previously prevents excessive charging and discharging, and thus improves safety and reliability of the battery. The battery state information may include a state of charge (SOC), a state of heath (SOH), a depth of discharging (DOD), a state of function (SOF), or the like.

The battery 13 may include battery cells (not illustrated) connected in series and/or parallel, and the battery cells may be high-voltage battery cells for electric vehicles, such as nickel metal battery cells, lithium ion battery cells, lithium polymer battery cells, lithium sulfur battery cells, sodium sulfur battery cells, and all-solid-state battery cells. In general, a high-voltage battery refers to a battery used as a power source for moving the electric vehicle and having a high voltage of 100 V or higher. However, the present disclosure is not limited thereto, and a low-voltage battery may be used.

The charging circuit 15 may function to charge the battery 13 inside the vehicle by converting an alternating current (AC) power into a direct current (DC) power. To this end, the charging circuit 15 may include an input filter that removes noise from an AC power that is an input power, a power factor corrector (PFC) circuit that increases energy efficiency, and a DC/DC converter for stably supplying power to the battery.

The connector 16 of the electric vehicle may be connected to the charging circuit 15. The connector 16 may be electrically connected to the charger 20 through a charging port in an outlet-inlet manner. In an embodiment, the connector 16 may constitute an inlet, and the charger 20 may constitute an outlet.

A charging control device 100 for an electric vehicle according to the embodiment may be included in the charging controller 11 or implemented as a separate device. Hereinafter, for convenience of description, an example in which the charging control device 100 is implemented as a separate device will be described.

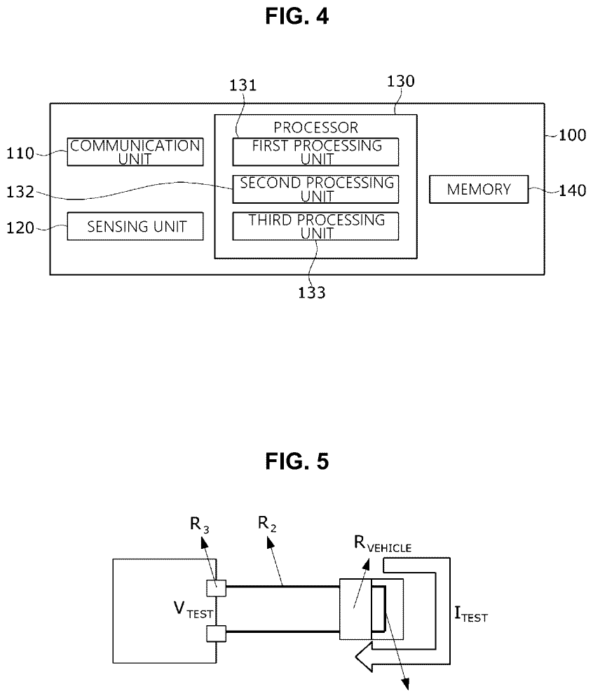

FIG. 4 is a block diagram of a charging control device for an electric vehicle according to the embodiment.

Referring to FIG. 4, the charging control device 100 according to the embodiment may include a communication unit 110, a sensing unit 120, a processor 130, and a memory 140.

The charging control device 100 for an electric vehicle according to the embodiment may be implemented in a logic circuit by hardware, firmware, software, or a combination thereof and may also be implemented using a general-purpose or specific-purpose computer. The device may be implemented using a hardwired device, a field programmable gate array (FPGA), an application specific integrated circuit (ASIC), or the like. Further, the device may be implemented in a system on chip (SoC) including one or more processors 130 and a controller.

In addition, the charging control device 100 for an electric vehicle may be mounted on a computing device or server equipped with a hardware element in the form of software, hardware, or a combination thereof. The computing device or server may mean any device including all or some of a communication device such as a communication modem for communication with various devices and wired/wireless communication networks, the memory 140 for storing data for executing a program, and the microprocessor for executing the program to perform calculations and commands.

The communication unit 110 may communicate with the sensing unit 120, the charger, and the electric vehicle to collect data.

The communication unit 110 may support communication with the charging controller and the charger and an electronic control unit (ECU) and sensors mounted on the vehicle. The communication unit 110 may include a transceiver that transmits or receives a controller area network (CAN) message using a CAN protocol. Further, the communication unit 110 may include a wireless communication circuit and/or a wired communication circuit or the like.

The communication unit 110 may receive a first charging voltage and a first charging current of the charger. The first charging voltage and the first charging current may mean a voltage value and a current value corresponding to power supplied from the charger when the electric vehicle is charged.

The communication unit 110 may receive temperature information of the charging port from the sensing unit 120. The temperature information of the charging port may mean a temperature value around the charging port in a state in which the inlet and the outlet are coupled to each other.

Further, the communication unit 110 may communicate with electric vehicle to receive electric vehicle information and store the received electric vehicle information in a database. For example, the electric vehicle information may include plug-in charger information, a current SoC, a target SoC, resource type information, battery capacity information, battery charge/discharge efficiency, expected entry time, expected exit time information, a charging count, and the like. The number of times the electric vehicle is charged is the total number of times the electric vehicle is charged through the charger and may be calculated cumulatively from the first charging.

The sensing unit 120 may measure a second charging voltage of the charging controller for the electric vehicle, which corresponds to the first charging voltage of the charger. The sensing unit 120 may include a current transformer mounted on a voltage input terminal of the charging controller. The sensing unit 120 may generate second charging voltage data by measuring a voltage of the input terminal of the charging controller when receiving a control signal from the processor 130 or according to a preset cycle.

Further, the sensing unit 120 may measure a test voltage of the charging controller, which corresponds to a test current. The test voltage may mean a voltage between both sides of the input terminal of the charging controller.

Further, the sensing unit 120 may include a temperature sensor. The temperature sensor may be mounted on the charging port to detect a temperature around the charging port and generate temperature data.

The memory 140 may include a database DB. The memory 140 may be a non-transitory storage medium that stores instructions to be executed by the processor 130. The memory 140 may include at least one of storage media such as a random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS) and/or a web storage.

The processor 130 may include at least one of processing devices such as the ASIC, a digital signal processor (DSP), a programmable logic device (PLD), the FPGA, a central processing unit (CPU), a microcontroller and/or the microprocessor.

The processor 130 may include a first processing unit 131, a second processing unit 132, and a third processing unit 133.

The first processing unit 131 may calculate a total resistance of the charging controller and the charger using the first charging voltage, the first charging current, and the second charging voltage. In the embodiment, the total resistance may include a charging controller-side resistance, a charger-side resistance, and a contact resistance.

The charging controller-side resistance may include an inlet resistance, a cable resistance, and a connector resistance of the charging controller of the electric vehicle. The charging controller-side resistance may be measured using the charging controller and the inlet configured as a closed circuit, and the measured value may be stored in the database.

The cable resistance may mean a resistance occurring in a cable that transmits power from the charger to the electric vehicle. A value of the cable resistance may vary depending on a length, a thickness, and a used material (e.g., copper, aluminum, or the like) of the cable.

The connector resistance may mean a resistance occurring in the connector that connects the charger and the vehicle. The connector resistance may increase and generate heat when a contact condition of the connector is not good.

The inlet resistance may mean a resistance occurring at a contact point between a charging connector and the charging port of the electric vehicle. The inlet resistance may impede flow of electricity and affect charging efficiency and safety. The inlet resistance is a resistance occurring at a point at which the charging connector and the charging port of the vehicle are in contact with each other and may be affected by or affect quality of connection, material properties, a temperature, or the like.

FIG. 5 is a view for describing an operation of the second processing unit 132 according to the embodiment. Referring to FIG. 5 together, the closed circuit may be formed by temporarily adding an electrical connection unit to be connected to an inlet-side terminal. The charging controller may apply the test current to the closed circuit, and the sensing unit 120 may measure the test voltage of the charging controller, which corresponds to the test current. Since the test voltage is a voltage between both sides of the input terminal of the charging controller, the charging controller-side resistance may mean an equivalent resistance of the closed circuit when viewed from the input terminal of the charging controller toward the inlet. The first processing unit 131 may calculate a charging controller-side resistance that is a value obtained by dividing the test voltage by the test current as in Equation 1 below.

$$\frac{{V}_{TEST}}{{I}_{TEST}} = {R}_{VEHICLE} + {R}_{2} + {R}_{3} = {R}_{control} \qquad [ Equation 1 ]$$

In Equation 1, V_{TEST}V_{TEST} is a test voltage, I_{TEST}I_{TEST} is a test current, R₂R₂ is a cable resistance, R₃R₃ is a connector resistance, R_{VEHICLE}R_{VEHICLE} is an inlet resistance, and R_{control}R_{control} is a charging controller-side resistance.

The charger-side resistance may be an internal resistance of the charger. The internal resistance of the charger is a specific resistance value that each charger has, and may be measured in advance and stored in the database along with an identification signal of the charger. The charger-side resistance may mean a resistance that occurs in components constituting the charger, such as a power conversion circuit (AC/DC converter or the like) inside the charger. The charger-side resistance may affect efficiency of the charger.

The contact resistance may mean a variable resistance that occurs when the inlet is coupled to the charger. That is, the contact resistance is a resistance that occurs at a point at which the charging connector and the charging port of the electric vehicle are in contact with each other and is increased when a contact surface is dirty or oxidized. The contact resistance may be a resistance that constitutes a portion of the inlet resistance.

Thus, the total resistance may mean an equivalent resistance when the charging circuit formed by the charging controller and the charger is viewed from the charging controller side in a state in which the inlet of the electric vehicle is connected to the charging port.

The first processing unit 131 may calculate a total resistance according to Equation 2 below.

$${R}_{all} = {R}_{all} = ( {V}_{CHARGER} - {V}_{VEHICLE} {V}_{CHARGER} - {V}_{VEHICLE} ) / {I}_{CHARGE} {I}_{CHARGE} \qquad [ Equation 2 ]$$

In Equation 2, RₐₗₗRₐₗₗ is a total resistance, I_{CHARGE}I_{CHARGE} is a first charging current, V_{CHARGER}V_{CHARGER} is a first charging voltage, and V_{VEHICLE}V_{VEHICLE} is a second voltage.

The second processing unit 132 may calculate the contact resistance between the inlet of the electric vehicle and the charger by comparing the charging controller-side resistance and the charger-side resistance, which are stored in advance, with the total resistance.

The second processing unit 132 may calculate, as the contact resistance, a resistance value obtained by excluding the charging controller side-resistance and the charger-side resistance from the total resistance.

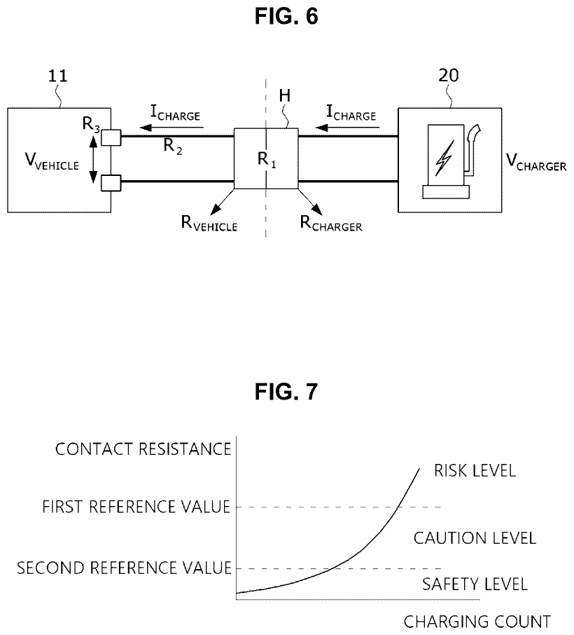

FIG. 6 is a view for describing an operation of the second processing unit 132 according to the embodiment. Referring to FIG. 6 together, the total resistance may include the charging controller-side resistance, the charger-side resistance, and the contact resistance. Among them, the charging controller-side resistance may be measured after the closed circuit is formed, and the charger-side resistance may be identified through the data stored in the database. Thus, the second processing unit 132 may calculate the contact resistance by excluding the charge controller-side resistance and the charger-side resistance from the total resistance as in Equation 3 below.

$${R}_{C} {R}_{C} = {R}_{1} + {R}_{2} + {R}_{3} {R}_{1} + {R}_{2} + {R}_{3} = {R}_{all} {R}_{all} - ( {R}_{VEHICLE} + {R}_{CHARGER} + {R}_{2} + {R}_{3} {R}_{VEHICLE} + {R}_{CHARGER} + {R}_{2} + {R}_{3} ) \qquad [ Equation 3 ]$$

In Equation 3, R_{C}R_{C} is a contact resistance, R₁R₁ is a total resistance of a corresponding part when the charger and a charging inlet are coupled, R₂R₂ is a cable resistance, R₃R₃ is a connector resistance, RₐₗₗRₐₗₗ is a total resistance, R_{VEHICLE}R_{VEHICLE} is an inlet resistance, and R_{CHARGER}R_{CHARGER} is a charger-side resistance.

That is, when the charging voltage and the charging current of the charger when charging is performed by the charger and the voltage value measured when the electric vehicle is actually charged are measured, the total resistance of the charging circuit may be calculated, and the contact resistance may be determined by subtracting the charging controller-side resistance and the charger-side resistance, which are calculated in advance, from the total resistance.

The second processing unit 132 may calculate an expected contact resistance value using charging count information and the contact resistance.

The second processing unit 132 may calculate the expected contact resistance value by utilizing an increase in the contact resistance according to the charging count.

The contact resistance that occurs due to the coupling between the charger and the inlet of the electric vehicle has a variable value since states of a charging station/charger may be different for each charging but may be calculated through Equation 2.

Further, the second processing unit 132 may calculate the expected contact resistance value using the charging count information and a change or increase in the actual measurement contact resistance that is increased according to the charging count.

The third processing unit 133 may determine a charging risk degree by comparing the contact resistance with a reference value. The third processing unit 133 may continuously calculate the contact resistance during charging of the electric vehicle, monitor the increase in the contact resistance due to heating of the charging port in real time to determine the charging risk degree, and determine whether to continuously perform charging according to the charging risk degree.

FIG. 7 is a view for describing an operation of the third processing unit 133 according to the embodiment. Referring to FIG. 7 together, the third processing unit 133 may output a charging stop signal when the contact resistance is greater than a preset first reference value and may output a control command for reducing the first charging current when the contact resistance is greater than a second reference value. The third processing unit 133 may determine the charging risk degree as a risk level when the contact resistance is greater than the first reference value, determine the charging risk degree as a caution level when the contact resistance is between the first reference value and the second reference value, and determine the charging risk degree as a safety level when the contact resistance is smaller than or equal to the second reference value. The third processing unit 133 may output the charging stop signal when it is determined that the charging risk degree is the risk level and output a charging check signal or a first charging current reduction signal when it is determined that the charging risk degree is the caution level. The third processing unit 133 may not output a separate signal or output a charging continuation signal when it is determined that the charging risk degree is the safety level.

In the embodiment, the first reference value may be greater than the second reference value, and the first reference value and the second reference value may be determined based on an initial contact resistance value. The initial contact resistance value may mean a contact resistance value calculated when the electric vehicle performs first charging. The third processing unit 133 may set a resistance value increased by b % of the initial contact resistance as the first reference value and may set a resistance value increased by c % of the initial contact resistance as the second reference value (b and c are positive numbers that satisfy the relationship b>c). The first reference value and the second reference value may be set in advance based on various factors that determine a charging environment of the electric vehicle and may be continuously updated and changed.

Alternatively, the third processing unit 133 may output a charging check command to the terminal when the contact resistance exceeds the second reference value. Upon receiving a charging check completion command from the terminal, the third processing unit 133 may calculate the contact resistance again to determine the charging risk degree.

Further, the third processing unit 133 may determine the charging risk degree using the contact resistance and the temperature information. When the charging is performed according to the reduced first charging current, the third processing unit 133 may determine the charging risk degree by additionally utilizing the temperature information of the charging port and determine whether to continuously perform charging according to the charging risk degree. The third processing unit 133 may output the charging stop signal when a temperature of the charging port is greater than a reference temperature.

When the temperature of the charging port is smaller than or equal to the reference temperature, the third processing unit 133 may calculate an amount of heat of the charging port, which is generated by the contact resistance during the charging, and an expected charging time. The third processing unit 133 may calculate an expected temperature of the charging port according to the calculated heat amount and the calculated expected charging time and determine the charging risk degree according to the expected temperature. The third processing unit 133 may output a first charging current reduction command or output the charging check command to the terminal according to the charging risk degree.

The third processing unit 133 may calculate an amount of heat of the charger using the contact resistance, a current atmospheric temperature, a current temperature of the charging port, the charging current, and the expected charging time. The atmospheric temperature may be extracted from weather information received through the communication unit 110, and the expected charging time may be calculated using the current SoC and target SoC of the electric vehicle information, output of the charger, and charging efficiency.

For example, the third processing unit 133 may calculate the amount of heat of the charger according to Equation 4 below.

$$Q = t * {I}^{2} * {R}_{C} \qquad [ Equation 4 ]$$

In Equation 4, Q is an amount of heat of the charging port, t is a time [s] during which a charging current flows, I is a charging current [A] of the charger, and Rc is a contact resistance [Ω].

The third processing unit 133 may calculate an expected temperature of the charging port through the amount of heat of the charging port, which is generated by the contract resistance during charging, and the expected charging time and additionally determine the charging risk degree according to the expected temperature.

Further, the third processing unit 133 may determine whether to perform pre-charging using the expected contact resistance value. The third processing unit 133 may determine that the charging is not possible when the expected contact resistance value deviates from a preset charging allowable range.

When the electric vehicle is repeatedly charged, the charging controller-side resistance increases depending on the charging count.

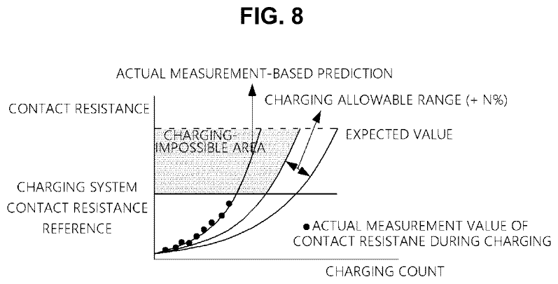

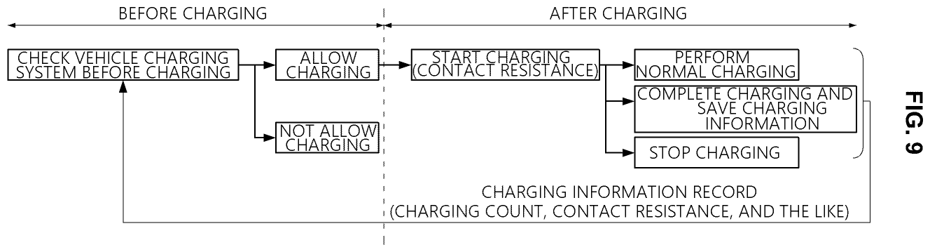

FIG. 8 is a view for describing an operation of the third processing unit 133 according to the embodiment. Referring to FIG. 8, the second processing unit 132 may store the calculated charging controller-side resistance in the database to correspond to the charging count and generate a graph in which the charging count and the charging controller-side resistance are an x axis and a y axis, respectively. The second processing unit 132 may output a charging-impossible signal using a slope of the contact resistance in the generated graph when the expected contact resistance value deviates from a preset charging allowable slope. That is, when the expected contact resistance value deviates from the charging allowable range, this means that an increase in the resistance does not belong to a normal range, it may be seen that there is a possibility of a fire occurring during charging, and thus the charging-impossible signal may be output to the electric vehicle and the terminal in a previous charging operation.

When the charging count is smaller than or equal to a preset reference count, the third processing unit 133 performs the charging and performs continuous monitoring using the contact resistance as described above.

FIG. 9 is a view for describing an entire operation process of a device according to the embodiment.

Referring to FIG. 9 together, the processor 130 according to the embodiment may determine whether to perform the charging using the charging count before the electric vehicle is charged and the charging controller-side resistance. Before the vehicle is charged, the processor 130 may form the closed circuit using a blocking connector, apply a very low current to the charging controller, and measure the charging controller-side resistance. The charging controller compares the measured charging controller-side resistance with an initial component resistance and outputs the charging-impossible signal when a change deviates from a reference value through the comparison of the initial component resistance. When outputting the charging-impossible signal, the charging control device 100 may also output a signal that guides vehicle inspection to the terminal of a vehicle owner. The processor 130 may output a charging-allowable signal when the amount of change in the charging controller-side resistance does not deviate from the reference value.

Further, the processor 130 may calculate the expected contact resistance value using the charging count and the actually measured contact resistance and output an alarm signal to the vehicle owner to inspect the vehicle before the charging when it is determined that a fire occurs.

Further, the processor 130 may calculate the contact resistance while the charging is performed. The processor 130 may output the charging stop signal when the contact resistance is greater than the first reference value and output a control signal to reduce the charging current of the charger to continuously perform charging when the contact resistance is greater than the second reference value smaller than the first reference value.

The processor 130 may output the charging stop signal when it is determined that the temperature of the charging port is out of an allowable range or the contact resistance is greater than the first reference value or the second reference value while continuously performing charging in a state of the low charging current.

The processor 130 may store charging progress information and charging completion information in the database when charging is completed or stopped.

Hereinafter, a process of determining whether to perform charging before charging and a process of determining whether to continuously perform charging while charging will be described in detail.

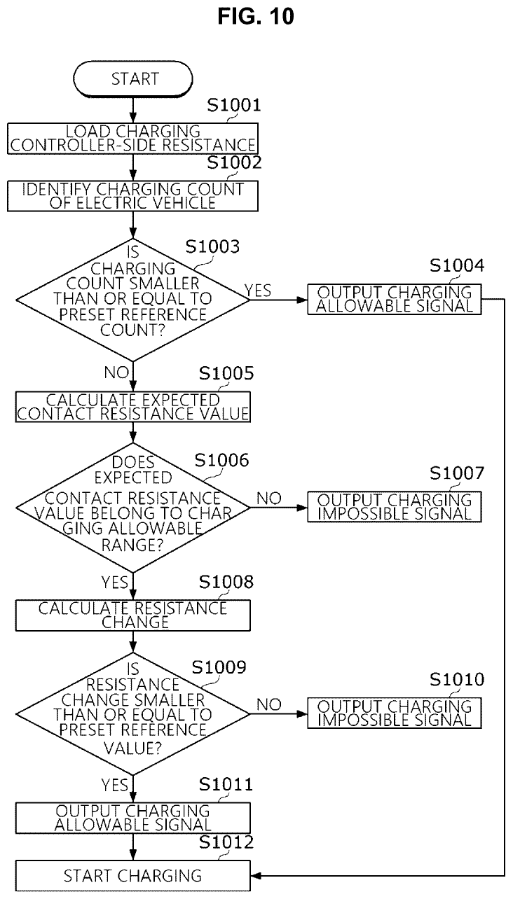

FIG. 10 is a flowchart of a charging control method for the electric vehicle according to the embodiment.

Referring to FIG. 10, first, a processor loads the charging controller-side resistance that is measured in advance and stored in the database (S1001).

Next, the processor may identify the charging count of the electric vehicle that is a charging target using information received from the electric vehicle or the information stored in the database (S1002).

Next, the processor compares the charging count with a preset reference count (S1003).

The processor outputs a charging allowable signal when the charging count is smaller than or equal to the reference count (S1004).

Alternatively, the processor calculates the expected contact resistance value when the charging count is greater than a preset count (S1005).

Next, the processor compares the expected contact resistance value with the charging allowable range and outputs the charging-impossible signal when the expected contact resistance value deviates from the charging allowable range (S1006 and S1007).

Alternatively, the processor calculates a resistance change amount by comparing the charging controller-side resistance with a charging controller-side initial resistance when the expected contact resistance value does not deviate from the charging allowable range (S1008).

The processor outputs the charging-impossible signal when the resistance change amount deviates from a preset reference value (S1009 and S1010).

Alternatively, the processor outputs the charge allowable signal when the resistance change amount does not deviate from the reference value, and the charger starts charging (S1011 and S1012).

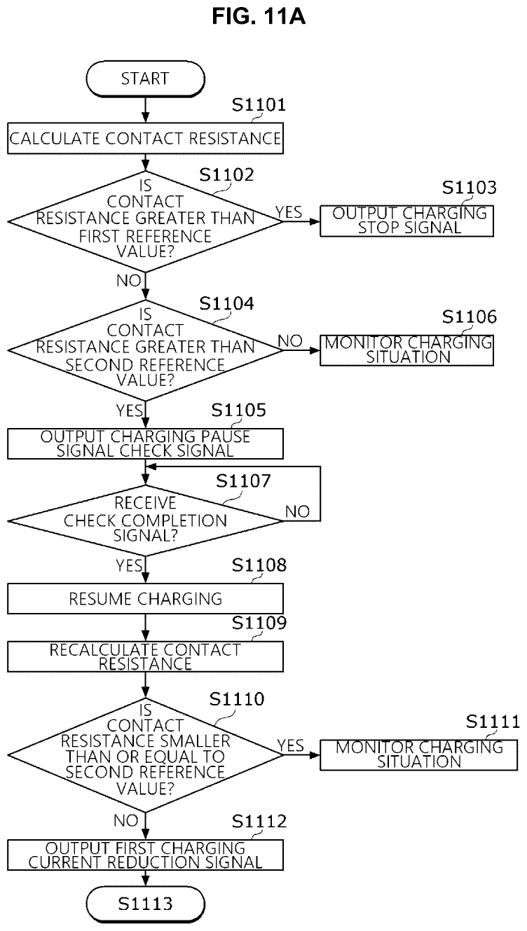

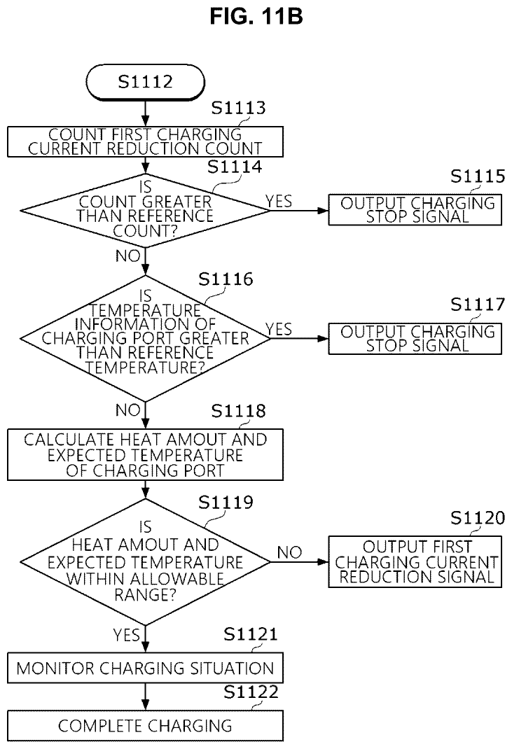

FIGS. 11A-11B are flowcharts of a charging control method for the electric vehicle according to another embodiment.

Referring to FIG. 11A, the processor calculates a total resistance using the first charging voltage and the first charging current on the charger side and the second charging voltage on the charging controller side and calculates the contact resistance using the total resistance (S1101).

Next, the processor compares the contact resistance with the first reference value and the second reference value (S1102).

Next, the processor outputs the charging stop signal when the contact resistance is greater than the first reference value (S1103).

Alternatively, when the contact resistance is smaller than or equal to the first reference value and greater than the second reference value, the processor outputs a charging pause signal to the charger and outputs a check signal to the terminal of the vehicle owner (S1104 and S1105).

Alternatively, the processor monitors a charging situation by periodically calculating the contact resistance without stopping charging when the contact resistance is smaller than or equal to the second reference value (S1106).

When receiving a check completion signal from the terminal, the processor resumes charging (S1107 and S1108).

The processor calculates the contact resistance again after charging is resumed (S1109).

The processor monitors the charging situation by periodically calculating the contact resistance without stopping charging when the re-calculated contact resistance is smaller than or equal to the second reference value (S1110 and S1111).

Next, the processor outputs the first charging current reduction signal when the contact resistance is greater than the second reference value (S1112).

Referring to FIG. 11B, the processor counts a first charging current reduction count (S1113).

The processor outputs the charging stop signal when the count is greater than a reference count (S1114 and S1115).

When the count is smaller than or equal to the reference count, the processor compares the temperature information of the charging port received through the communication unit with the reference temperature (S1116).

Next, the processor outputs the charging stop signal when the temperature information of the charging port is greater than the reference temperature (S1117).

Alternatively, the processor calculates the amount of heat of the charging port and the expected temperature of the charging port when the temperature information of the charging port is smaller than or equal to the reference temperature (S1118).

The processor outputs the first charging current reduction signal when the amount of heat and the expected temperature deviate from preset allowable ranges (S1119 and S1120).

The processor determines whether to continuously perform charging depending on the counting number of the first charging current reduction signal (S1114 and S1115).

Alternatively, the processor periodically monitors the charging situation using the contact resistance and the temperature information without stopping the charging when the amount of heat and the expected temperature do not deviate from the allowable ranges (S1121).

Next, the processor stores charging execution information in the database when the charging is completed according to the target SoC, the expected vehicle exit time, or the like and outputs a charging completion signal (S1122).

A charging control device and method for an electric vehicle according to an embodiment can determine whether to continuously perform charging according to a contact resistance during charging of an electric vehicle.

Further, a charging current can be adjusted according to a contact resistance to reduce heat generation.

Further, a possibility of fire occurrence can be checked through checking a temperature and an amount of heat of a charging port, and whether to continuously perform charging can be determined.

Further, a possibility of fire occurrence can be determined using a previous charging record and a contact resistance before charging starts, and whether to start charging can be determined.

Further, a possibility of an abnormality in a charging system can be checked and feedbacked to a driver or manager.

Although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A charging control device for an electric vehicle, the charging control device comprising:
a communication unit configured to receive a first charging voltage and a first charging current of a charger;
a sensing unit configured to measure a second charging voltage of a charging controller for the electric vehicle, which corresponds to the first charging voltage;
a processor configured to:
calculate a total resistance of the charging controller and the charger using the first charging voltage, the first charging current, and the second charging voltage;
compare a pre-stored charging controller-side resistance and a pre-stored charger-side resistance with the total resistance and calculate a contact resistance between an inlet of the electric vehicle and the charger; and
compare the contact resistance with a reference value and determine a charging risk degree.

2. The charging control device of claim 1, wherein the processor comprises at least first, second, and third processors respectively configured to calculate the total resistance of the charging controller, compare the pre-stored charging controller-side resistance and the pre-stored charger-side resistance with the total resistance, and compare the contact resistance with the reference value.

3. The charging control device of claim 1, wherein the processor calculates, as the contact resistance, a resistance value obtained by excluding the charging controller-side resistance and the charger-side resistance from the total resistance.

4. The charging control device of claim 1, wherein the charging controller-side resistance includes an inlet resistance of the electric vehicle, a cable resistance, and a connector resistance of the charging controller.

5. The charging control device of claim 4, wherein the charging controller side-resistance is measured using the charging controller and the inlet formed as a closed circuit and stored in a database.

6. The charging control device of claim 1, wherein the charger-side resistance is an internal resistance of the charger.

7. The charging control device of claim 1, wherein the processor outputs a charging stop signal when the contact resistance is greater than a preset first reference value and outputs a control command for reducing the first charging current when the contact resistance is greater than a second reference value.

8. The charging control device of claim 7, wherein the first reference value is greater than the second reference value, and the first reference value and the second reference value are determined based on an initial contact resistance value.

9. The charging control device of claim 1, wherein the communication unit receives charging count information of the electric vehicle, and
the processor calculates an expected contact resistance value using the charging count information and the contact resistance.

10. The charging control device of claim 9, wherein the processor determines whether to perform charging in advance using the expected contact resistance value, and calculates the expected contact resistance value using an increase in the contact resistance according to the charging count.

11. The charging control device of claim 10, wherein the processor determines that charging is impossible when the expected contact reference value deviates from a preset charging allowable range.

12. The charging control device of claim 1, wherein the communication unit receives temperature information of a charging port, and
the processor determines the charging risk degree using the contact resistance and the temperature information.

13. An electric vehicle comprising the charging control device of claim 1.

14. A charging control method for an electric vehicle, the charging control method comprising:
receiving, by a communication unit, a first charging voltage and a first charging current of a charger;
measuring, by a processor, a second charging voltage of a charging controller for the electric vehicle, which corresponds to the first charging voltage;
calculating, by the processor, a total resistance of the charging controller and the charger using the first charging voltage, the first charging current, and the second charging voltage;
comparing, by the processor, a pre-stored charging controller-side resistance and a pre-stored charger-side resistance with the total resistance and calculating a contact resistance between an inlet of the electric vehicle and the charger; and
comparing, by the processor, the contact resistance with a reference value and determining a charging risk degree.

15. The charging control method of claim 14, wherein the determining of the charging risk degree includes outputting a charging stop signal when the contact resistance is greater than a preset first reference value and outputting a control command for reducing the first charging current when the contact resistance is greater than a second reference value.

16. The charging control method of claim 14, further comprising, before the determining of the charging risk degree:
receiving, by the communication unit, charging count information of the electric vehicle; and
calculating an expected contact resistance value using the charging count information and the contact resistance.

17. The charging control method of claim 16, further comprising:
determining whether to perform charging in advance using the expected contact resistance value.

18. The charging control method of claim 17, wherein the calculating of the expected contact resistance value includes calculating the expected contact resistance value using an increase in the contact resistance according to the charging count.

19. The charging control method of claim 17, wherein the determining of whether to perform the charging in advance determines that charging is impossible when the expected contact resistance value deviates from a preset charging allowable range.

20. The charging control method of claim 14, wherein the determining of the charging risk degree includes:
receiving, by the communication unit, temperature information of a charging port; and
determining the charging risk degree using the contact resistance and the temperature information.
